(19) United States
(12) Patent Application Publication
(10) Pub. No.: US 2012/0059143 A1
(43) Pub. Date: Mar. 8, 2012

(54) PREPARING POLYESTER ALCOHOLS

(75) Inventors: Gerlinde Tischer, Ruhland (DE); Ulrike Mahn, Mannheim (DE); Stefan Käshammer, Schifferstadt (DE); Hermann Graf, Mutterstadt (DE); Christian Seitz, Heidelberg (DE); Christian Nitschke, Speyer (DE); Dieter Rodewald, Hong Kong (CN)

(73) Assignee: BASF SE, Ludwigshafen (DE)

(21) Appl. No.: 13/227,068

(22) Filed: Sep. 7, 2011

Related U.S. Application Data
(60) Provisional application No. 61/380,350, filed on Sep. 7, 2010.

(51) Int. Cl. C08G 63/80; C08G 63/668

(52) U.S. Cl. 528/301

(57) ABSTRACT

The subject of the present invention is a process for preparing polyester alcohols by condensation of polytetrahydrofuran with aromatic dicarboxylic acids and/or their anhydrides in the presence of a transesterification catalyst in a multi-stage operation at different pressure levels with at least one reaction stage at atmospheric pressure and at least one reaction stage at reduced pressure, where distillate is removed from the reaction system, which process comprises heating the reaction mixture in two or more phases in the atmospheric-pressure reaction stage wherein the heating phases are interrupted by at least one phase in which the temperature is kept constant.

This patent application claims the benefit of pending U.S. provisional patent application Ser. No. 61/380,350 filed Sep. 7, 2010 incorporated in its entirety herein by reference.

This invention relates to a process for preparing polyester alcohols based on polytetrahydrofuran and aromatic dicarboxylic acids such as isophthalic acid and also to the use of these polyester alcohols for preparing polyurethaneurea-based elastic fibers (elastane, or synonymously spandex) having a particularly flat hysteresis curve, known in the literature as “soft elastane” or “soft spandex”. Elastane fibers are described for example in H. J. Koslowski, “Dictionary of Man-Made Fibers”, 1st edition 1998, International Business Press Publishers GmbH, Frankfurt/Main, ISBN 3-87150-583-8, on p. 69 et seq.

Preparing polyester alcohols, also known as polyester polyols, by polycondensation reactions of polybasic carboxylic acids with polyhydric alcohols, or polyols, has been extensively described. By way of example there may be cited Kunststoffhandbuch, volume VII, Polyurethane, Carl-Hanser-Verlag, Munich 1st edition 1966, edited by Dr. R. Vieweg and Dr. A. Höchtlen, and also 2nd edition 1983 and the 3rd revised edition 1993, edited by Dr. G. Oertel.

Using these polyesterols particularly in the manufacture of polyurethane (PU) products, more particularly elastic fibers based on polyurethaneurea, which have a particularly flat hysteresis curve, requires careful choice of the materials used and of the polycondensation technology to be applied. It is known to use aromatic and/or aliphatic dicarboxylic acids/anhydrides and di-, tri- and/or polyfunctional alcohols, more particularly glycols, which are made to react at temperatures of particularly 150-250° C. under atmospheric pressure and/or slightly reduced pressure in the presence of catalysts by removing the water of reaction. The customary technology, described in DE-A-2904184 for example, is to add the reaction components at synthesis commencement with a suitable catalyst coupled with concurrent raising of the temperature and lowering of the pressure. The temperatures and the vacuum are then further changed in the course of the synthesis.

When the polycondensation reaction involves multiple acids and/or alcohols, individual reaction materials may also only be added in the course of the reaction. Usually, the condensation reaction is carried out under atmospheric pressure or slightly reduced pressure up to the removal of the low-boiling components (water, methanol). After the evolution of low boilers has ended, still other reaction components are then added if appropriate, temperature changes are made and the beginning of the vacuum phase is shifted toward the high-vacuum phase.

Polyester alcohols based on polytetrahydrofuran and isophthalic acid are known per se from WO 2007/122124 for example. There is a general desire to ensure a very high functionality on the part of the polyester alcohols. Too low a functionality has the result that the polyurethane prepared therefrom has too low a molar mass, which in turn leads to inadequate mechanical properties, since these correlate positively with the molar mass. Polytetrahydrofuran and isophthalic acid are generally condensed by the prior art processes under reduced pressure to polyester alcohols of inadequate functionality.

Functionality herein refers to the so-called end group functionality of the polyester alcohol. When all the ends of the polyester alcohol molecules bear an OH group, the functionality value is 2.000. When reacting polyester alcohols with diisocyanates, the chain lengths achieved for the prepolymers increase with the functionality of the polyester alcohols.

Since the synthesis of the polyesterol to which this invention relates has the polycondensation being accompanied by secondary reactions which lead to polyester polymer chains having an allyl group at one end and a hydroxyl group at the other, the functionality of the polyester alcohols is determined via the iodine number to DIN 53241-1. This determination is also customary in the case of the polyetherols.

It is an object of the present invention to develop a process for preparing polyester polyalcohols based on polytetrahydrofuran and aromatic dicarboxylic acids whereby these polyesterols are simple and economical to prepare with high functionality.

We have found that this object is achieved by an operating regime in the atmospheric-pressure stage of the process for preparing polyester alcohols wherein the reaction mixture of the aromatic dicarboxylic acid and/or its anhydrides and polytetrahydrofuran is heated in at least two reaction portions, i.e., two temperature ramps, which are interrupted by a constant-temperature phase, a temperature plateau.

The present invention accordingly provides a process for preparing polyester alcohols by condensation of polytetrahydrofuran with aromatic carboxylic acids and/or their anhydrides, preferably isophthalic acid, phthalic acid, terephthalic acid and their anhydrides and more preferably isophthalic acid, in the presence of a transesterification catalyst, for example titanium tetrabutyl orthotitanate, tetraisopropyl orthotitanate, dibutyltin laurate, dibutyltin oxide, tin octoate, tin chloride, tin oxide, sulfuric acid, para-toluenesulfonic acid, potassium hydroxide, sodium methoxide, titanium zeolites, lipases or hydrolases immobilized on a carrier, preferably tetrabutyl orthotitanate (cross comparison) wherein in a multi-stage operation at different pressure levels with at least one reaction stage at atmospheric pressure and at least one reaction stage at reduced pressure, where distillate is removed from the reaction system, which process comprises heating the reaction mixture in two or more phases in the atmospheric-pressure reaction stage wherein the heating phases are interrupted by at least one phase in which the temperature is kept constant.

The polyester alcohols prepared according to the present invention from isophthalic acid and polytetrahydrofuran preferably have a DIN 53241-1 iodine number of <0.5 g I2/100 g, preferably <0.2 g I2/100 g and more preferably <0.1 g I2/100 g. The functionality of the polyester alcohols prepared according to the present invention is accordingly at least 1.94, preferably >1.976 and more preferably >1.988.

The reaction mixture in the first heating phase is heated to a temperature T₁ where T₁=130 to 190° C., preferably 180° C., in the course of 0.1 to 15 h. In the first phase, the temperature T₁ can be reached by continuous heating (temperature ramping), or this temperature ramping may be interrupted by at least one phase of constant temperature delta T₁ (temperature plateau) where delta T₁ is preferably from 1 to 10° C. lower than T₁. The second heating phase takes the temperature, in the course of 1 to 20 h, to a temperature T_{end}=200 to 230° C., preferably 220° C. Again, this second phase can be reached by continuous heating to the end temperature of the atmospheric-pressure reaction stage T_{end}, or be interrupted by at least one phase of constant temperature delta T₂ (temperature plateau) where delta T₂ is preferably from 1 to 20° C. lower than T_{end}.

Preferably, the temperature between the heating phases to the end temperature of the atmospheric-pressure reaction stage (temperature-ramping phases) is twice kept constant, corresponding to two temperature plateaus. The temperature between the heating phases is preferably kept constant for two times 0.5 to 10 hours (h), preferably 1 to 5 h and more preferably 1 to 4 h.

The atmospheric-pressure reaction stage corresponds to the time for heating to Tₑ and is preferably carried out in an overall time of 2 to 15 hours and more preferably 2.5 to 8 hours.

The synthesis of the polyester alcohols is carried out under (trans)esterification conditions and can take place in a solvent. Preferably, when polytetrahydrofuran and aromatic dicarboxylic acids are reacted, no solvent is used.

To avoid oxidation and attendant loss of functionality, the condensation of polytetrahydrofuran with aromatic dicarboxylic acids, preferably isophthalic acid, phthalic acid and terephthalic acid and more preferably isophthalic acid, is advantageously carried out under an inert-gas atmosphere. Useful inert gases include, for example, nitrogen, carbon dioxide or noble gases, preference being given to nitrogen. The inert-gas atmosphere is intended to reduce the oxygen content of the reaction apparatus to less than 0.1% by volume.

The transesterification catalyst, for example tetrabutyl orthotitanate, tetraisopropyl orthotitanate, dibutyltin laurate, dibutyltin oxide, tin octoate, tin chloride, tin oxide, sulfuric acid, para-toluene sulfonic acid, potassium hydroxide, sodium methoxide, titanium zeolites, lipases or hydrolases, immobilized on a carrier, preferably tetrabutyl orthotitanate, is preferably added from 2 to 4 h after attainment of temperature Te and before application of the vacuum. Preferably, tetrabutyl orthotitanate is added in polytetrahydrofuran of an average molecular weight of 250 to 1000 daltons and/or 1,4-butanediol as solvent. The concentration of the titanium tetrabutylate in the solvent is from 1% to 15% by weight, preferably from 2% to 10% by weight and more preferably from 5% to 10% by weight.

The reduced-pressure reaction stage is preferably carried out at a pressure <1013 to 2 mbar, preferably at from 2 to 100 mbar and more preferably at from 2 to 50 mbar.

The polyester alcohols are prepared by the process of the present invention, as observed, by reacting polytetrahydrofuran with aromatic dicarboxylic acids and/or their anhydrides, preferably isophthalic acid. The starting materials used for the process of the present invention will now be described in detail.

The reduced-pressure reaction stage is preferably carried out in an overall time of 2 to 15 hours and more preferably from 2.5 to 8 hours.

Polytetrahydrofuran (PTHF) is typically produced in industry, in a conventional manner, by polymerization of tetrahydrofuran—hereinafter abbreviated to THF—over suitable catalysts. Suitable reagents can be added to control the chain length of the polymer chains and hence the average molecular weight. Such reagents are known as chain-terminating reagents or “telogens”. It is through the choice of which telogen and which amount thereof that control is effected. Suitable telogens additionally enable functional groups to be introduced at one or both of the ends of the polymer chain. Industrially, acetic anhydride or water are frequently used as telogens. The process is described in the DE 19801462 patent for example.

The PTHF used in the process of the present invention preferably has an average molecular weight in the range from 250 to 3000 daltons and more preferably in the range from 250 to 2000 daltons, such as PTHF 250, PTHF 450, PTHF 650, PTHF 1800 and PTHF 2000. PTHF with an average molecular weight of 400-1000 daltons is particularly preferably used, PTHF with an average molecular weight of 650 daltons being very particularly preferred. By “average molecular weight” or “average molar mass” herein is meant the number average Mₙ of the molecular weight of the polymers, determined by wet-chemical OH number determination for example.

The aromatic dicarboxylic acid used is an aromatic dicarboxylic acid, preferably isophthalic acid, phthalic acid and terephthalic acid, more preferably isophthalic acid.

To prepare the polyester polyol, isophthalic acid is advantageously polycondensed with polytetrahydrofuran in a molar ratio of 1:0.9 to 1:0.5, preferably 1:0.8 to 1:0.7 and more preferably 1:0.75.

The catalyst can be deactivated using an inorganic acid in a molar ratio of catalyst to phosphoric acid in the range from 1:1 to 1:3.5, preferably in the range from 1:1.1 to 1:2.4 and more preferably in the range from 1.1 to 1:1.4. The inorganic acid used is preferably phosphoric acid.

The polyester alcohols prepared by the process of the present invention can be for example converted by reaction with polyisocyanates and thereafter with di- and monoamines to form polyurethaneurea-based elastic fibers (also known as elastane or spandex fibers) which have a particularly flat hysteresis curve.

The process of the present invention provides a distinct improvement in the manufacture of polyester alcohols from aromatic dicarboxylic acids, preferably isophthalic acid, phthalic acid and terephthalic acid, more preferably isophthalic acid and polytetrahydrofuran. The polyester alcohols are simple and economical to produce with high functionality.

The examples which follow illustrate the invention.

### EXAMPLES

### Molecular Weight Determination

The average molecular weight Mn in the form of the number average molecular weight, defined as the mass of all PTHF molecules divided by their amount in moles, is determined by determining the hydroxyl number in polytetrahydrofuran. The hydroxyl number is the amount of potassium hydroxide in mg which is equivalent to the amount of acetic acid bound in the course of the acetylation of 1 g of substance. The hydroxyl number is determined via the esterification of the existing hydroxyl groups with an excess of acetic anhydride.

H—[O(CH2)4]n-OH+(CH3CO)2→CH3CO—[O(CH2)4]n-O—COCH3+H2O

After the reaction, excess acetic anhydride is hydrolyzed with water in accordance with the following reaction equation:

(CH3CO)2O+H2O→2CH3COOH

and backtitrated as acetic acid with sodium hydroxide solution.

### Determination of Iodine Number

The iodine number was determined by Kaufmann's method (DGF standard method C-V 11b). The iodine number is a measure of the level of unsaturated carbon-carbon double bonds. The determination is based on the ability of halogens (bromine in this case) to add onto double bonds. It is determined by backtitration of the unconsumed amount of halogen. It is expressed in g of iodine/100 g of substance.

1 g of sample is weighed out accurately to 0.001 g and after addition of 10 ml of 1:1 (v/v) cyclohexane/glacial acetic acid, is admixed with 25 ml of a bromine solution prepared from 120-150 g of sodium bromide (previously dried at 130° C.) in 1000 ml of methanol and 5.20 ml of bromine. Next 20 ml of potassium iodide solution (100 g/l of potassium iodide) and 100 ml of distilled water are added, and the released iodine is titrated with 0.1 mol/l of sodium thiosulfate solution initially to a yellow color, after addition of some aqueous starch solution (5 g/l starch) the then violet-black batch to the point of colorlessness.

### Determination of OH Number

The hydroxyl group content was determined by determining the “OH number” according to DIN 53240-2. To this end, all the OH groups were reacted with an excess of acetylating reagent (acetic anhydride) and the excess acid equivalents were determined by volumetric titration with potassium hydroxide solution. The OH number is that amount of potassium hydroxide in mg which is equivalent to the amount of acetic acid bound by 1 g of substance in the acetylation.

Determination of Functionality from Iodine Number and OH Number

The determination of the functionality from iodine number and OH number is described in N. Barksby, G. L. Allen, Polyurethane World Congress 1993, p. 445-450.

The synthesis of the polyester alcohol is accompanied by a secondary reaction which leads to the formation of polymer chains having a terminal allyl ether group, known as monools. The monool fraction present alongside the difunctional polyester alcohol leads to reduced functionality.

The monool content is determined by titrating the terminal double bond of the allyl group with mercuric acetate/alcoholic potassium hydroxide, i.e., by analyzing the level of unsaturation, expressed in milliequivalents per gram of polyol. From the degree of unsaturation (“unsat”=iodine number, in meq/g) and the hydroxyl number (“OH” in mg KOH/g), the functionality f can be calculated by applying the formula 1)

$$f = \frac{( \frac{OH}{56.1} )}{[ ( \frac{OH}{56.1} ) - unsat ] \cdot ( \frac{1}{{f}_{n}} ) + unsat} , \qquad ( 1 )$$

where fₙ is the nominal functionality for the polyester alcohol in consideration (for diols, i.e., in our case, fₙ=2). For a conventional polyester alcohol with a molecular weight Mn=4000, f is in the range of 1.7.

Water Content Determination After Karl Fischer (DIN EN 60814)

Water content was determined by Karl Fischer titration. To this end, from 1 to 3 ml of the sample solution were injected into an automat for determining the water content by the Karl Fischer method (Metrohm Karl Fischer Coulometer KF756). The measurement was done coulometrically and is based on the Karl Fischer reaction, the water-mediated reaction of iodine with sulfur dioxide.

Determination of Color Number (ASTM D 4890 EN or DIN ISO 6271)

The polymers freed of solvent were measured untreated in a LICO 200 liquid colorimeter from Dr. Lange. Precision cuvettes type No. 100-QS (path length 50 mm, from Helma) are used.

Determination of Acid Number (DIN EN 12634)

The ester and carboxylic acid content of the starting materials (of the carboxyl groups present in the mixture) was determined by determining the “ester number” and the “acid number” by methods known to a person skilled in the art. To determine the acid number, all the carboxylic acids present were neutralized with an excess of potassium hydroxide and the remaining quantity of potassium hydroxide was determined by volumetric titration with hydrochloric acid. To determine the saponification number, all the esters present were saponified with an excess of ethanolic potassium hydroxide. The remaining quantity of potassium hydroxide was determined by volumetric titration with hydrochloric acid. The ester number is the difference between the saponification number thus determined and the previously determined acid number. The ester number is the amount of potassium hydroxide in mg which is equivalent to the amount of acetic acid bound by 1 g of substance in the acetylation.

### Determination of Viscosity

Viscosity was determined in accordance with DIN 53019-1 at 60° C. with a Physica MCR101 viscometer (mounted on an air bearing) from Anton Paar (millipascal second=mPas). The instrument has an Anton Paar Drypoint membrane dryer, Haake DC10 thermostat (water temperature controlled to 30° C.), a PC with Rheoplus/32 V3.10 software (connection via serial interface), a compressed-air supply (BASF 3 bar line).

The liquid to be investigated is positioned in the measuring gap of the viscometer between the cone: Anton Paar CP50-1 and the plate: Anton Paar Peltier P-PTD 200 (cone-plate distance: 0.05 mm), of which one rotates at an angular velocity Ù (rotor) and the other is stationary (stator). (Time setting: 15 data points each involving 5 seconds (s) of measurement (of that the instrument needs 2.5 s to adjust to the respective shear rate. In the next 2.5 s, the torque sensor measures raw data every 2 ms (1250 values), shear rate: ramp 10-100 1/s logarithmic, measurement temperature: 60° C., trim position: 0.06 mm, measurement position: 0.05 mm). The 15 data points are measured at the shear rates 10, 11.8, 13.9, 16.4, 19.3, 22.8, 26.8, 31.6, 37.3, 43.9, 51.8, 61.1, 72, 84.8, 100 [1/s], the value reported herein being that obtained at a shear rate of 100 [1/s].

### Examples 1 to 9

### Preparing Polyester Alcohols (Inventive)

In a 4 l flask equipped with heating, stirring and distillation means, the amounts of isophthalic acid and poplytetrahydrofuran 650 which are reported in table 1 were in succession three times degassed, inertized with nitrogen and then heated to 180° C. under atmospheric pressure. The heating rate was adjusted such that the 180° C. came about after 2 hours.

The polycondensation ensued at a temperature of 180° C. under atmospheric pressure. This temperature was maintained for 3 h. This was followed by heating to 205° C., and this temperature was maintained for 2 h and thereafter increased to T_{end}. After this temperature had been maintained for 3 h, titanium tetrabutoxide was added in the form of a 1% by weight solution in PTHF 650 before starting the vacuum phase. A vacuum of 20 mbar was applied. Water is distilled to reach an acid number of less than 1 in the course of time 1.

On reaching the desired acid number, the system is cooled down to 190° C. To deactivate the catalyst 85% by weight phosphoric acid was added. The batch was cooled down to room temperature and the quality of the ester was tested via iodine number, color number, OH number, acid number, viscosity and water content. The specific reaction conditions and values determined are shown in table 1.

### Example 10

### Preparing a Polyester Alcohol Mn 3000 g/mol (Inventive)

In a 4 l flask equipped with heating, stirring and distillation means, 375.4 g of isophthalic acid and 1956.08 g of polytetrahydrofuran 650 (denotes an average molecular weight of 650 g/mol) were in succession three times degassed, inertized with nitrogen and then heated to 180° C. under atmospheric pressure. The heating rate was adjusted such that the 180° C. came about after 2 hours.

The polycondensation ensued at a temperature of 180° C. under atmospheric pressure. This temperature was maintained for 3 h. This was followed by heating to 205° C., maintained for 2 h, and thereafter 220° C. After this temperature had been maintained for 3 h, 11.25 g (50 ppm) of tetrabutyl orthotitanate were added in the form of a 1% by weight solution in PTHF 650 before starting the vacuum phase. A vacuum of 20 mbar was applied. Water is distilled to reach an acid number of less than 1 in the course of 8 h.

On reaching the desired acid number, the system is cooled down to 190° C. To deactivate the catalyst 0.045 g (20 ppm) of 85% by weight phosphoric acid was added. The batch was cooled down to room temperature and the quality of the ester was tested via iodine number, color number, OH number, acid number, viscosity and water content. The values are shown in table 1.

TABLE 1

| | | | | | | | | | | | | Viscosity | |
|---|---|---|---|---|---|---|---|---|---|---|---|---|---|
| | | | | | | | | Iodine | Color | | OH | mPas shear | |
| | MW | | | | | T_{end} | | number | number | S-Zahl | number | rate 100 | Water |
| Ex. | g/mol | IPA g | PTHF g | KAT g | H₃PO4 g | ° C. | Time1 h | glodine/100 g | Hazen | mg/g | mg/g | [1/s], 60° C. | ppm |
| 1 | 2500 | 356.6 | 1974.71 | 11.25 | 0.045 | 220 | 7 | <0.1 | 31 | 0.21 | 44.78 | 1900 | 103 |
| 2 | 2750 | 366 | 1965.39 | 11.25 | 0.045 | 220 | 7 | <0.1 | 25 | 0.11 | 39.92 | 2600 | 80 |
| 3 | 4000 | 398.9 | 1932.79 | 11.25 | 0.045 | 220 | 7 | <0.1 | 22 | 0.08 | 28.11 | 6740 | 122 |
| 4 | 4500 | 410.6 | 1921.15 | 11.25 | 0.045 | 220 | 8 | <0.1 | 18 | 0.08 | 25.65 | 10500 | 106 |
| 5 | 5000 | 417.6 | 1914.16 | 11.25 | 0.045 | 220 | 9 | <0.1 | 23 | 0.09 | 23.62 | 15500 | 108 |
| 6 | 3000 | 375.4 | 1956.08 | 1.125 | 0.011 | 220 | 32 | 0.2 | 22 | 0.61 | 37.08 | 2840 | 83 |
| 7 | 3000 | 375.4 | 1956.08 | 4.5 | 0.018 | 220 | 15 | <0.1 | 23 | 0.75 | 38.04 | 2760 | 87 |
| 8 | 3000 | 375.4 | 1956.08 | 6.75 | 0.023 | 220 | 13 | <0.1 | 26 | 0.7 | 37.88 | 2866 | 165 |
| 9 | 3000 | 375.4 | 1956.08 | 9 | 0.038 | 220 | 9 | <0.1 | 24 | 0.33 | 38.24 | 2910 | 108 |
| 10 | 3000 | 375.4 | 1956.08 | 11.25 | 0.045 | 220 | 6 | <0.1 | 27 | 0.24 | 38.37 | 2840 | 62 |

MW = molecular weight of polyester alcohol
IPA = isophthalic acid (166 g/mol)
PTHF = polytetrahydrofuran (MW 650 g/mol)
KAT = tetrabutyl orthotitanate (340.16 g/mol)
H₃PO4 = phosphoric acid (98 g/mol)
S-Zahl = acid number
T_{end} = end temperature after ramp
Time1 = reaction time in vacuum phase
S-Zahl = acid number

### Comparative Example 1 to Inventive Example 6

In a 4 l flask equipped with heating, stirring and distillation means, 375.4 g of isophthalic acid, 1956.08 g of polytetrahydrofuran 650 and 1.125 g (5 ppm) of tetrabutyl orthotitanate in the form of a 1% by weight solution in PTHF 650 were in succession added, three times degassed, inertized with nitrogen and then heated to 220° C. under atmospheric pressure. The heating rate was adjusted such that the 220° C. came about after 9 hours. A vacuum of 20 mbar was applied. Water is distilled to reach an acid number of less than 1 in the course of 32 h.

On reaching the desired acid number, the system is cooled down to 190° C. To deactivate the catalyst 0.011 g (5 ppm) of 85% by weight phosphoric acid was added. The batch was cooled down to room temperature and iodine number, color number, OH number, acid number, viscosity and water content were tested. The following values were determined:

| | |
|---|---|
| iodine number [g/100 g] | 0.6 |
| color number [Hazen] | 113 |
| OH number [g/100 g] | 36.05 |
| acid number [g/100 g] | 0.89 |
| viscosity [mPas, shear rate 100 [1/s], 60° C.] | 2910 |
| water content [ppm] | 350 |

### Comparative Example 2 to Inventive Example 7

In a 4 l flask equipped with heating, stirring and distillation means, 375.4 g of isophthalic acid, 1956.08 g of polytetrahydrofuran 650 and 4.5 g (20 ppm) of tetrabutyl-orthotitanate in the form of a 1% by weight solution in PTHF 650 were in succession added, three times degassed and inertized with nitrogen and then heated to 220° C. under atmospheric pressure. The heating rate was adjusted such that the 220° C. came about after 9 hours. A vacuum of 20 mbar was applied. Water is distilled to reach an acid number of less than 1 in the course of 15 h.

On reaching the desired acid number, the system is cooled down to 190° C. To deactivate the catalyst 0.018 g (8 ppm) of 85% by weight phosphoric acid was added. The batch was cooled down to room temperature and iodine number, color number, OH number, acid number, viscosity and water content were tested. The following values were determined:

| | |
|---|---|
| iodine number [g/100 g] | 0.7 |
| color number [Hazen] | 45 |
| OH number [g/100 g] | 36.2 |
| acid number [g/100 g] | 0.21 |
| viscosity [mPas, shear rate 100 [1/s], 60° C.] | 2950 |
| water content [ppm] | 180 |

### Comparative Example 3 to Inventive Example 10

In a 4 l flask equipped with heating, stirring and distillation means, 375.4 g of isophthalic acid, 1956.08 g of polytetrahydrofuran 650 and 11.25 g (50 ppm) of tetrabutyl-orthotitanate in the form of a 1% by weight solution in PTHF 650 were in succession added, three times degassed and inertized with nitrogen and then heated to 220° C. under atmospheric pressure. The heating rate was adjusted such that the 220° C. came about after 9 hours. A vacuum of 20 mbar was applied. Water is distilled to reach an acid number of less than 1 in the course of 8 h.

On reaching the desired acid number, the system is cooled down to 190° C. To deactivate the catalyst 0.045 g (20 ppm) of 85% by weight phosphoric acid was added. The batch was cooled down to room temperature and the iodine number, color number, OH number, acid number, viscosity and water content were tested. The following values were determined:

| | |
|---|---|
| iodine number [g/100 g] | 0.7 |
| color number [Hazen] | 163 |
| OH number [g/100 g] | 38.2 |
| acid number [g/100 g] | 0.971 |
| viscosity [mPas, shear rate 100 [1/s], 60° C.] | 2918 |
| water content [ppm] | 220 |

1.-9. (canceled)

10. A process for preparing polyester alcohols by condensation of polytetrahydrofuran with aromatic dicarboxylic acids and/or their anhydrides in the presence of a transesterification catalyst in a multi-stage operation at different pressure levels with at least one reaction stage at atmospheric pressure and at least one reaction stage at reduced pressure, where distillate is removed from the reaction system, which process comprises heating the reaction mixture in two or more phases in the atmospheric-pressure reaction stage wherein the heating phases are interrupted by at least one phase in which the temperature is kept constant.

11. The process according to claim 10 wherein the reaction mixture in the first heating phase is heated to a temperature T₁ where T₁=130 to 190° C. for 0.1 to 15 h.

12. The process according to claim 10 wherein the reaction mixture in the second heating phase is heated to a temperature T_{end}=200 to 230° C. for 3 to 12 h.

13. The process according to claim 10 wherein the temperature is twice kept constant between the heating phases.

14. The process according to claim 10 wherein the temperature is twice kept constant between the heating phases for 1 to 10 h.

15. The process according to claim 10 wherein the overall heating time to T_{end} is in the range from 1 to 20 h.

16. The process according to claim 10 wherein the catalyst is added after attainment of temperature T_{end} and before application of the vacuum.

17. The process according to claim 10 wherein the catalyst is added in polytetrahydrofuran or 1,4-butanediol.

18. The process according to claim 10 wherein the reduced-pressure reaction stage is carried out at a pressure in the range from less than 1013 to 2 mbar.
